(19) United States
(12) Patent Application Publication
(10) Pub. No.: US 2026/0213983 A1
(43) Pub. Date: Jul. 23, 2026

(54) AMBIENT POWER WIFI UPLINK PREAMBLE SYNC DESIGN

(71) Applicant: NXP USA, Inc., AUSTIN, TX (US)

(72) Inventors: Rui Cao, Sunnyvale, CA (US); Sergey Timofeev, Mountain View, CA (US); Hongyuan Zhang, Fremont, CA (US); Xilin Cheng, Menlo Park, CA (US); Franz Amtmann, Graz (AT); Zheng Guo, Newark, CA (US)

(21) Appl. No.: 19/345,749

(22) Filed: Sep. 30, 2025

Related U.S. Application Data
(60) Provisional application No. 63/747,926, filed on Jan. 22, 2025.
(60) Provisional application No. 63/783,722, filed on Apr. 4, 2025.
(60) Provisional application No. 63/828,518, filed on Jun. 23, 2025.
(60) Provisional application No. 63/870,402, filed on Aug. 26, 2025.

(51) Int. Cl. H04L 27/02; H04L 27/26

(52) U.S. Cl. CPC H04L 27/02; H04L 27/2605; H04L 27/2655

(57) ABSTRACT

Methods and apparatus are provided for communications between an ambient power (AMP) tag device by an AMP-compliant WiFi device. A method includes generating, by an AMP tag device, an UL backscatter physical layer protocol data unit (PPDU) segment. The UL backscatter PPDU includes an UL AMP preamble having an UL AMP synchronization (SYNC) field that includes an On-Off keying (OOK) modulated SYNC sequence. The SYNC sequence may be a repetitive OOK modulated waveform that is Manchester encoded. The UL backscatter PPDU of this method further includes an UL data frame. The method further includes transmitting, by the AMP tag device, the UL backscatter PPDU for reception by an AMP-compliant WiFi device.

### CROSS REFERENCE TO RELATED APPLICATIONS

The present U.S. Utility Patent application claims priority pursuant to 35 U.S.C. § 119 (e) to U.S. Provisional Application No. 63/747,926, entitled “AMBIENT POWER WIFI UPLINK PREAMBLE SYNC DESIGN”, filed Jan. 22, 2025, U.S. Provisional Application No. 63/783,722, entitled “REFERENCE SYMBOL DESIGN FOR AMBIENT POWER WIFI WAVEFORM”, filed Apr. 4, 2025, U.S. Provisional Application No. 63/828,518, entitled “AMBIENT POWER WIFI UPLINK PREAMBLE SYNC DESIGN FOR PPM ESTIMATION”, filed Jun. 23, 2025, and U.S. Provisional Application No. 63/870,402, entitled “AMBIENT POWER WIFI UPLINK PREAMBLE SYNC DESIGN FOR PPM ESTIMATION”, filed Aug. 26, 2025, the contents of each of which is hereby incorporated herein by reference in its entirety and made part of the present U.S. Utility Patent Application for all purposes.

### TECHNICAL FIELD

This disclosure relates generally to data communications, and more particularly, to methods and apparatus for ambient power uplink communications based on Institute of Electrical and Electronics Engineers (IEEE) 802.11 bp.

### BACKGROUND

Existing Ultra-High Frequency Radio Frequency Identification (UHF RFID) standards, such as EPC Gen2, provide an air-interface protocol that defines how passive RFID tags and readers communicate through battery-less backscattering in the UHF band (approximately 860-930 MHz). Ambient Power (AMP) communication is currently being discussed in the Institute of Electrical and Electronics Engineers (IEEE) Task Group bp for the 802.11.bp amendment to the 802.11 standard. AMP communication is intended to enable low power operation of AMP tag devices through battery-less backscattering in a 2.4 GHz range.

### BRIEF DESCRIPTION OF THE DRAWINGS

One or more embodiments will now be described by way of example only with reference to the accompanying drawings, in which:

FIG. 1 illustrates an example of an ambient power (AMP) communication system in accordance with embodiments of the present disclosure;

FIG. 2 illustrates an example protocol for WiFi backscatter communication in accordance with embodiments of the present disclosure;

FIG. 3A illustrates example details of the AMP portion of a PPDU in accordance with one or more embodiments of the present disclosure;

FIG. 3B illustrates another example of the AMP portion of a PPDU in accordance with one or more embodiments of the present disclosure;

FIG. 4 illustrates an example of the backscattering segment of a PPDU in accordance with one or more embodiments of the present disclosure;

FIG. 5 illustrates various examples of an AMP postamble field of a PPDU in accordance with embodiments of the present disclosure;

FIG. 6 illustrates an example of an AMP uplink (UL) waveform in accordance with one or more embodiments of the present disclosure;

FIG. 7A illustrates an example of an AMP uplink (UL) SYNC field in accordance with an embodiment of the present disclosure;

FIG. 7B illustrates another example of an AMP UL SYNC field in accordance with an embodiment of the present disclosure;

FIG. 7C illustrates another example of an AMP UL SYNC field in accordance with an embodiment of the present disclosure;

FIGS. 8A-8E illustrate various examples of the contents of an AMP UL SYNC field in accordance with embodiments of the present disclosure;

FIG. 9 illustrates an example of WiFi backscatter communication in accordance with embodiments of the present disclosure;

FIGS. 10A-10C illustrate further examples of an AMP DL carrier waveforms including reference symbols in accordance with embodiments of the present disclosure;

FIG. 11 illustrates an example of a random phase carrier waveform in accordance with an embodiment of the present disclosure;

FIG. 12A illustrates examples of polarity sequences for reference symbols in accordance with embodiments of the present disclosure;

FIG. 12B illustrates additional examples of polarity sequences for reference symbols in accordance with one or more embodiments of the present disclosure;

FIG. 13A illustrates an example of reference symbols in accordance with one or more embodiments of the present disclosure;

FIG. 13B illustrates additional examples of reference symbols in accordance with one or more embodiments of the present disclosure;

FIGS. 14A-14D illustrate examples of an AMP UL SYNC field including a repetitive basic OOK waveform in accordance with embodiments of the present disclosure;

FIG. 15 illustrates an example of a basic OOK waveform with a length of 8 pulses in accordance with embodiments of the present disclosure;

FIG. 16 illustrates an example of a repetitive OOK waveform with a length of 8 pulses in accordance with embodiments of the present disclosure; and

FIG. 17 is a flow chart illustrating an example method for generating an AMP UL SYNC field in accordance with one or more embodiments of the present disclosure.

### DETAILED DESCRIPTION

The various implementations described in the following description relate generally to new physical layer protocol data unit (PPDU) formats and methodologies associated with Ambient Power (AMP) communications with an AMP-compliant WiFi device. More particularly, innovative PPDU formats are described to support ambient backscatter communications, wireless power transfer/RF energy harvesting, multiple data communication modes (e.g., a sub-1 GHz band communication mode and a 2.4 GHz band communication mode), coexistence mechanisms, and other features associated with the IEEE 802.11 bp amendment to the IEEE 802.11 standard. Briefly, the 802.11 bp amendment is intended to extend IEEE 802.11 MAC and PHY layers to support AMP stations (AMP STAs) that harvest energy for operation.

Embodiments disclosed herein are directed to a physical layer protocol data unit (PPDU) format associated with ambient power (AMP) communication between an AMP tag device and an AMP-compliant WiFi device that is able to co-exist with legacy WiFi devices and infrastructure in a WiFi network. In an example described more fully below, an ambient power (AMP) tag device generates an UL backscatter physical layer protocol data unit (PPDU) segment. The UL backscatter PPDU includes an UL AMP preamble having an UL AMP synchronization (SYNC) field that includes an On-Off keying (OOK) modulated SYNC sequence. The SYNC sequence may be a repetitive OOK modulated wave form that is Manchester encoded. The UL backscatter PPDU of this method further includes an UL data frame. The method further includes transmitting, by the AMP tag device, the UL backscatter PPDU for reception by an AMP-compliant WiFi device.

As used herein, the term “non-legacy” may refer to physical layer protocol data unit (PPDU) formats and communication protocols conforming with the IEEE 802.11bn amendment to the IEEE 802.11 standard (also referred to as Ultra High Reliability or “UHR” or “Wi-Fi 8”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard.

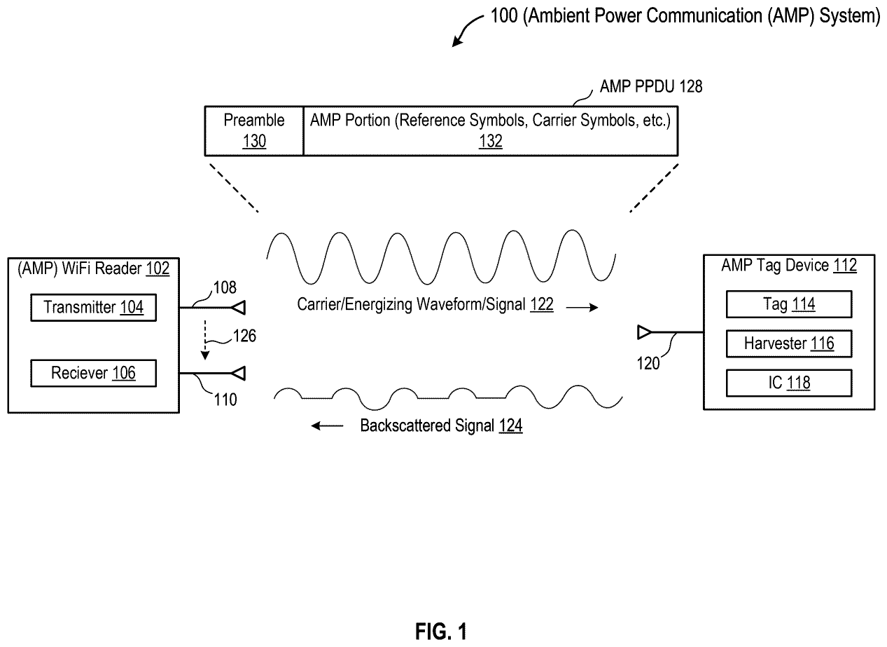

FIG. 1 illustrates an example of an ambient power (AMP) communication system 100 in accordance with embodiments of the present disclosure. The illustrated AMP communication system 100 includes an AMP tag device 112 and a WiFi reader 102 and that is AMP compliant and may operate to read (and in some cases write) data from/to the AMP tag device 112. The AMP tag device 112 and WiFi reader 102 may be implemented by one or more of analog circuitry, mixed-signal circuitry, memory circuitry, logic circuitry, and processing circuitry that executes code stored in a memory (is) to perform disclosed functions on one or more integrated circuits.

The AMP tag device 112 may be a device compatible with the 802.11 bp amendment to the IEEE 802.11 standard. In one or more embodiments, the AMP tag device 112 can be a battery-less backscattering tag device operable in one or more frequency sub-bands, such as sub-1 GHz and 2.4 GHz (or general sub-7 GHZ) frequency bands, and have one or more antenna 120 for transmitting or receiving in the operating frequency band(s). The AMP tag device 112 is typically a low-cost device, and has an energy efficient design by using a low cost voltage controlled oscillator (VCO) with no crystal and phase lock loop (PLL). The AMP tag device 112 may also have an integrated circuit (IC) 118 to facilitate transmitting or receiving signals in the one or more frequency bands based on timing of the VCO. A received signal may indicate a request from the WiFi reader 102 to read or write data in a memory of the AMP tag device 112 (also referred to herein as tag 114) and a transmitted signal may indicate data stored in the tag 114 or a response to a write operation. The AMP tag device 112 may further include a harvester 116 which extracts power from a (energizing/excitation) waveform 122 transmitted by the AMP-compliant WiFi reader 102 and incident on the antenna 120 in order to operate the integrated circuit (IC) 118 to receive and transmit signals.

An AMP tag device 112 may include an AMP IoT device, which can as sensors, monitors, actuators, etc. for various applications that may require low cost and maintenance-free/battery-less devices and/or small form factor devices. Such applications may include, for example, smart manufacturing, environmental sensing and monitoring (e.g., in data centers), asset management, smart home sensing and monitoring, smart agriculture applications, indoor positioning, smart power grid applications, food supply chain monitoring, etc. Such devices should also be backward compatible with existing WiFi signals and communications (e.g., 20 MHz channel bandwidths, symbol-based waveforms, and higher carrier frequencies (2.4 GHz, 5 GHZ, 6 GHZ, etc.).

In one or more embodiments, the waveform 122 may be a carrier waveform or energizing (carrier) waveform on which the data transmitted by the WiFi reader 102 is modulated, and on which the AMP tag device 112 backscatters data by modulation to define the signals transmitted by the AMP tag device 112. To transmit and receive the signals, the WiFi reader 102 of this example includes a transmitter 104, receiver 106 and one or more antenna such as antenna 108 and antenna 110. The WiFi reader 102 may take the form of a smart phone, smart home hub, public transportation hotspot, dedicated reader device, etc., and be compatible with one or more legacy and/or non-legacy amendments to the IEEE 802.11 standard.

The WiFi reader 102 of this example operates to transmit and receive WiFi signals in addition to signals transmitted for the operation of the AMP tag device 112. To achieve co-existence with other legacy WiFi devices (e.g., devices which do not support AMP communication), the WiFi reader 102 is arranged to transmit the waveform 122 to the AMP tag device 112 in the form of an AMP physical layer protocol data unit (PPDU) 128 including a preamble 130 having symbols that define a legacy WiFi preamble, e.g., a 802.11b preamble or legacy orthogonal frequency division multiplexed (OFDM) preamble (e.g., 802.11g/n/ac/ax/be), and a payload/AMP portion 132 of the PPDU. By including the legacy preamble, the AMP PPDU 128 is configured to allow other WiFi readers or legacy WiFi devices (not shown and not AMP compliant) to be able to decode the legacy preamble of the AMP PPDU 128 and backoff from transmitting for the duration of the AMP PPDU 128 (as indicated by the preamble) so as not to interfere with AMP communication between the WiFi reader 102 and the AMP tag device 112.

In one or more embodiments, the WiFi reader 102 may read data from the AMP tag device 112 or write data to the AMP tag device 112 by transmitting the AMP PPDU 128. The AMP PPDU 128 transmitted as the waveform 122 is incident on the antenna 120 of the AMP tag device 112. For passive AMP tag devices 112 that rely on backscattered communications, the harvester 116 of the AMP tag device 112 may harvest power from the waveform 122 defining the AMP PPDU 128 to power the IC 118 to receive and decode symbols in an AMP portion 132 of the PPDU which is in the payload of the AMP PPDU 128. Based on the symbols that are decoded in the AMP PPDU 128, the IC 118 may cause the AMP tag device 112 perform a read or write operation and transmit a response. The AMP tag device 112 may transmit the response by a backscattering process which involves modulating a portion of the waveform 122 incident on the antenna 120 to generate a backscatter signal 124. The impedance of the antenna 120 may be modulated based on bits of the response to modulate an amount of incident RF energy and scatter the amount of incident energy on the antenna 120 to transmit bits of the response from the AMP tag device 112 to the WiFi reader 102 as backscattering. The response may be data stored in the t AMP tag device 112 (e.g., an identifier associated with the tag, sensor measurement data, etc.) or a protocol compliant response control message. The WiFi reader 102 will then receive this backscatter signal 124. In some embodiments, the WiFi reader 102 may further send an acknowledgement to indicate the receipt of the response or uplink communication.

The modulation clock accuracy of AMP tag device 112 may be very limited, e.g., 100,000 parts per million (ppm) variation from a nominal value due to a low cost design. The ppm may be measure of a variation of modulation accuracy such as a 1 Hz change in frequency for every 1 MHz of frequency. Further, complexity associated with the reading of data may need to be put onto the WiFi reader 102, which needs to resolve a large sampling frequency offset (SFO) of the VCO of the AMP tag device 112.

In one or more embodiments, the WiFi reader 102 may need to send a well-designed waveform 122 to define the AMP PPDU 128. The waveform 122 may be the carrier waveform with a repeated base waveform. This way, signal leakage 126 from transmit antenna 108 to receive antenna 110 due to antenna coupling can be removed and the backscattered signal received by the WiFi reader 102 is able to be decoded with better signal-to-interference-and-noise ratio (SINR). The antenna coupling may be leakage of a signal transmitted by the transmitter 104 and received at the receiver 106. The waveform 122 may have defined design criteria such as a low peak to average power ratio (PAPR) to enable higher transmit power and better receive signal-to-noise ratio, a low power fluctuation for a duration of every symbol for which On-Off keying (OOK) modulation is applied for backscattering, and small spectral leakage due to the OOK. In an example, for 250 kbps OOK with Manchester encoding, a symbol duration is 2 μs, while for 1 Mbps OOK with Manchester encoding, a symbol duration is 0.5 μs. The OOK with Manchester encoding is a method of transmitting data where the waveform 122 is either on or off to represent a ‘1’ or ‘0’ bit, and the Manchester encoding ensures a transition occurs at the start of each bit period, aiding clock recovery and data integrity.

Signal leakage 126 may have a relatively high power and the same timing as the waveform 122, and the backscatter signal 124 received at the receiver 106 of the WiFi reader 102 may be masked by the signal leakage 126 which typically has a higher power. The WiFi reader 102 needs to remove this signal leakage 126 from a received signal at the receiver 106 to recover the backscatter signal 124 using a leakage estimation and removal process. Many ways of removing this signal leakage 126 are possible.

In one or more embodiments, a leakage in an Nth symbol of the AMP PPDU 128 that is received where N is an integer may be removed by subtracting a waveform of the N−1th symbol that is already received from a waveform of the Nth symbol. The differencing may reduce the signal leakage 126 but could result in destroying the Nth symbol modulation. In one or more embodiments, the WiFi reader 102 may transmit reference symbols in the AMP PPDU 128 and determine leakage of the reference symbols between the transmitter 104 and the receiver 106. The reference symbols may be predefined symbols that represent a predefined data sequence. Then, the WiFi reader 102 may transmit subsequent carrier symbols which the AMP tag device 112 receives in the AMP PPDU 128. The AMP tag device 112 may receive the AMP PPDU 128 and modulate data on a waveform of the carrier symbols based on backscattering to transmit data back to the WiFi reader 102, and the modulation parameters are determined based on control information in an AMP portion of the PPDU such as AMP data transmitted to the AMP tag device 112 which also includes a synchronization pattern and the reference symbols in some embodiments. The reference symbols may have a same format and content as the carrier symbols except for some phase or polarity differences, and the AMP tag device 112 does not backscatter any data within the duration of the reference symbols to allow for accurate signal leakage 126 determination. In some embodiments, the AMP tag device 112 may backscatter data bits to the WiFi reader 102 a predetermined time after sending the carrier symbols to allow for the WiFi reader 102 to estimate the signal leakage 126 based on the carrier symbols received during the non-backscattering time by the receiver 106. The WiFi reader 102 may receive the combined signal leakage 126 and backscattering signal 124 and then subtract the estimated signal leakage 126 based on reference symbols from the received signal to remove the signal leakage 126 and recover the backscatter signal 124 without the signal leakage 126.

In one or more embodiments, the WiFi reader 102 may send reference symbols periodically in the AMP PPDU 128 and instruct the AMP tag device 112 to skip performing a backscattering every N reference symbols for the WiFi reader 102 to determine the signal leakage 126. The estimation process may include estimating the reference symbols which are received based on the transmitted reference symbols to estimate the signal leakage 126. The WiFi reader 102 may then subtract, at the receiver 106, the estimated signal leakage 126 based on the reference symbols from a received signal to recover the backscatter signal 124 and remove the signal leakage 126. The periodic sending of the reference symbols or determining the signal leakage 126 allows for improving the signal leakage 126 estimation and recovery of the backscattered signal with higher signal-to-noise ratio.

In one or more embodiments, the portion of the waveform 122 that defines the reference symbols associated with leakage estimation and the carrier symbols that are backscattered may not be simple repeated symbols that cause a spectrum spike and violate transmit requirements. The portion of the waveform 122 may also be a known waveform that is received at the receiver 106 for signal leakage 126 estimation. The phase or polarity on the portion of the waveform 122 for signal leakage 126 estimation may need to be removed to perform the carrier symbol leakage estimation. In one or more embodiments, the portion of the waveform 122 may be an existing WiFi single-carrier waveform, e.g., as defined by IEEE 802.11b. The receiver 106 may need to remove any modulation (e.g., differential binary phase shift keying (DBPSK)) of 802.11b from the reference symbol portion of the waveform 122, estimate the leakage signal of the reference symbols, and regenerate carrier symbols with modulation recovered for signal leakage 126 removal. As a result, a waveform of the regenerated carrier symbols is subtracted from a received signal at the receiver 106 to recover the backscattered signal 124 resulting from backscattering a waveform of carrier symbols in the AMP PPDU 128 for signal leakage 126 removal.

While the foregoing description relates generally to backscattered communications, various methodologies described herein may likewise be applicable to non-backscattered communications, such as communications involving active or battery-powered tag devices that do not require (or only periodically require) an energizing waveform.

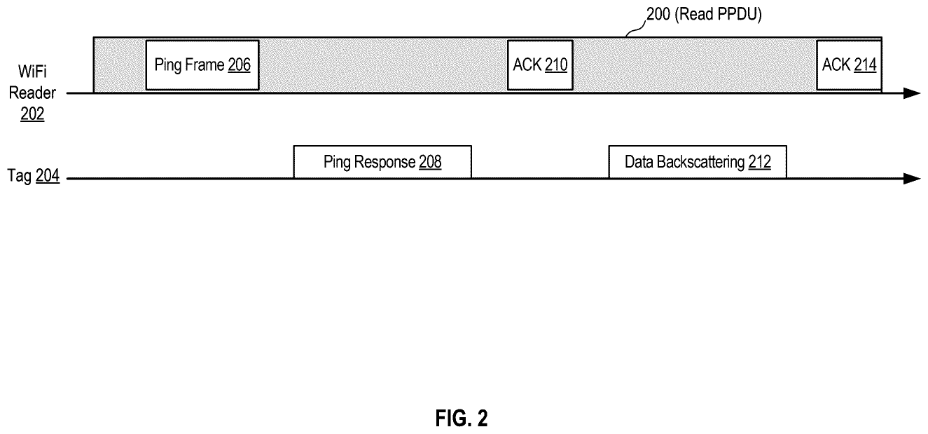

FIG. 2 illustrates an example protocol for WiFi backscatter communication in accordance with embodiments of the present disclosure. In the illustrated example, a WiFi reader 202 transmits a (read) PPDU 200 to an AMP tag 204. In this example, the PPDU 200 includes a ping frame 206 that solicits a ping response 208 from the AMP tag 204. The ping response 208 is acknowledged by ACK 210, and the AMP tag 204 performs data backscattering 212 (e.g., to provide solicited data stored in the AMP tag 204), which is then acknowledged by ACK 214. In this example, in addition to sending control information to the AMP tag 204, the (read) PPDU 200 may serve as the energizing carrier waveform for use in generating the ping response 208 and data backscattering 212.

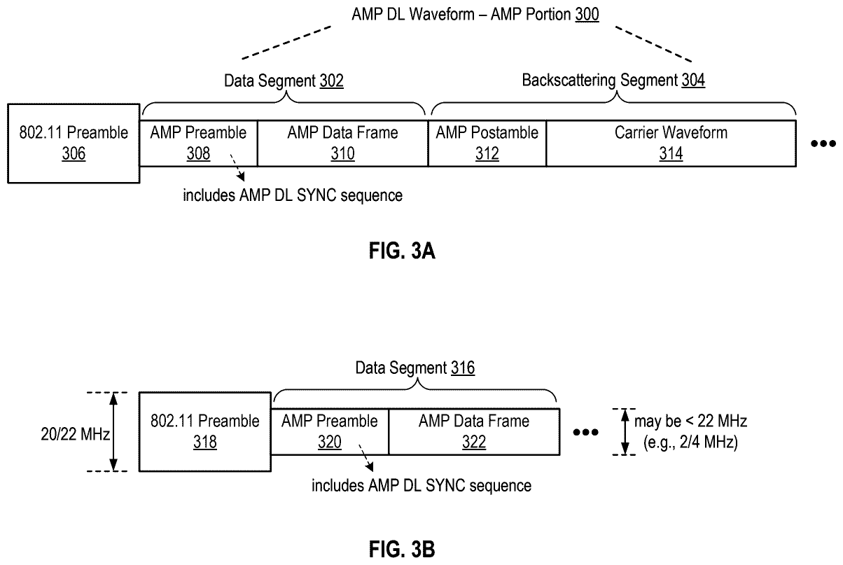

FIG. 3A illustrates example details of the AMP portion 300 of a PPDU in accordance with one or more embodiments of the present disclosure. The PPDU may be transmitted by a WiFi reader to an AMP tag device that relies on backscattered communications. In the illustrated embodiment, the AMP portion 300 is preceded by an 802.11-based preamble 306. In various examples, the preamble 306 is configured to provide coexistence with legacy WiFi devices, and may include either a 802.11b preamble or an OFDM preamble defined by 802.11g/n/ac/ax/be. The preamble 306 may indicate the duration of the entire (AMP) PPDU.

In this example, the AMP portion 300 of the PPDU is a unified AMP DL waveform that includes both a data segment 302 and a backscattering segment 304. The data segment 302 includes an AMP preamble 308 and an AMP data frame 310. As described more fully below, the AMP preamble 308 of this example includes an AMP DL synchronization (SYNC) sequence (e.g., an OOK modulated sequence) that allows a recipient device to detect the AMP preamble 308 and synchronize and calibrate reception of the AMP data frame 310. The AMP data frame 310 may carry carrier symbols modulated by the WiFi reader with data to be transmitted to an AMP tag.

The backscattering segment 304 of this example includes an AMP postamble 312 and a carrier waveform 314. The AMP postamble 312 may be included to indicate the start of the carrier waveform 314 or the end of the AMP data frame 310, and to cause other devices sharing the spectrum to continue to backoff transmissions. In an example, the carrier waveform 314 may include carrier symbols (e.g., all ON energy) which are not modulated by the WiFi reader and whose waveform is to be backscattered by a recipient AMP tag device to transmit data back to the WiFi reader as the backscatter signal 124. For example, the carrier waveform 314 can consist of a sequence of single carrier symbols having a specified bandwidth, and randomization of the polarity or phase of the symbols may be performed to mitigate spectrum spikes. Although not separately illustrated, the backscattering segment 204 may further include reference symbols that are configured to support leakage signal estimation by the WiFi reader.

The AMP portion 300 of this example may have a narrow bandwidth (e.g., 2 MHz or 4 MHz) as compared to the bandwidth of the 802.11 preamble 306 (e.g., 20/22 MHz). The narrow bandwidth may be determined, for example, by application of a DSSS spreading code that differs from a spreading code associated with the 802.11 preamble 306.

FIG. 3B illustrates another example of the AMP portion of a PPDU in accordance with one or more embodiments of the present disclosure. In an example, the PPDU may be transmitted by a WiFi reader to an AMP tag device that does not rely on backscattered communications (e.g., an active AMP tag device). In the illustrated embodiment, the AMP portion 300 includes a data segment 316 but does not include a backscattering segment. The data segment 316 of this example is preceded by an 802.11-based preamble 318, and includes an AMP preamble 320 and an AMP data frame 322. In various embodiments, the AMP preamble 320 includes a SYNC sequence that differs from that of the AMP preamble 308 of FIG. 3A (e.g., to accommodate different sampling rates). The illustrated sequences of FIGS. 3A and 3B may continue with multiple data segments and/or backscattering segments.

The various types of AMP tags having differing hardware capabilities. For example, some “high-end” tags (e.g., AMP-only active STAs and AMP-assisted WiFi devices/IoT devices may have front-end gain control and ADC sampling capabilities for performing ADC correlation-based SYNC detection, while “low-end” tags (e.g., backscattering AMP tags (or AMP STAs) may have no front-end gain control functionality and can only perform per-bit differential signal detection on an uplink carrier waveform.

In various embodiments described herein, UL PPDU SYNC field designs are provided to support AMP communications for both high-end and low-end tags. Each category of AMP devices may have different hardware design limitations. For example, AMP-only active STAs can support 1000 ppm, up to a 8 MHz clock rate, and a link budget of 90 dB. Backscattering AMP tags may have high ppm impairments up to 100,000 ppm, up to a 2 MHz clock rate, a link budget of 30 dB, and backscatter signals with a high SNR. Wakeup only AMP devices may have similar capabilities as active STAs/tags, including a link budget of 90 dB. Accordingly, multiple SYNC patterns can be defined to support different types of AMP STAs.

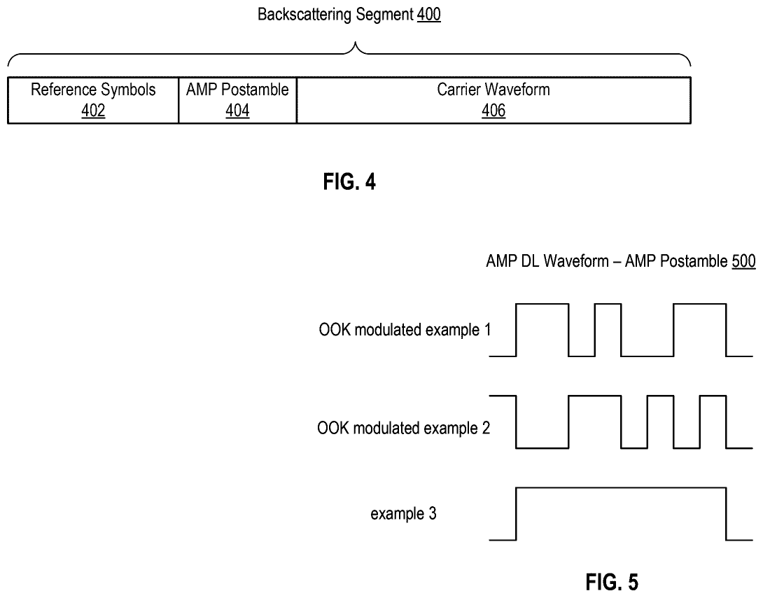

FIG. 4 illustrates an example of the backscattering segment 400 of a downlink (DL) PPDU in accordance with one or more embodiments of the present disclosure. The backscattering segment 400 of this example includes reference symbols 402, an AMP postamble field 404, and a carrier waveform 406 for use in backscattered communications with an AMP tag. The AMP postamble field 404 may be included to indicate the start of the carrier waveform 406 or the end of an AMP data frame of the transmitting device (e.g., a WiFi reader), and to cause other devices sharing the spectrum to continue to backoff transmissions. In an example, the carrier waveform 406 may include carrier symbols (e.g., all ON energy) which are not modulated by the WiFi reader and whose waveform is to be backscattered by a recipient AMP tag device to transmit data back to the WiFi reader as a backscatter signal. For example, the carrier waveform 406 can consist of a sequence of single carrier symbols having a specified bandwidth, and randomization of the polarity or phase of the symbols may be performed to mitigate spectrum spikes. The reference symbols 402 may be configured to support leakage signal estimation by the WiFi reader.

FIG. 5 illustrates various examples of an AMP postamble field 500 (such as the AMP postamble field 404 of FIG. 4) of an AMP DL PPDU in accordance with embodiments of the present disclosure. In general, the AMP postamble field 500 includes an OOK modulated waveform having a pattern that is distinguishable from other OOK modulated waveforms. In the illustrated first and second examples, the AMP postamble field 500 repeats all (or a truncated portion of) a DL preamble SYNC sequence. In the third example, the AMP postamble field 500 is a duration of an ON (or OFF) carrier with no transitions except for one transition at the end to indicate the start of a carrier waveform, and is distinguishable from a Manchester encoded OOK waveform.

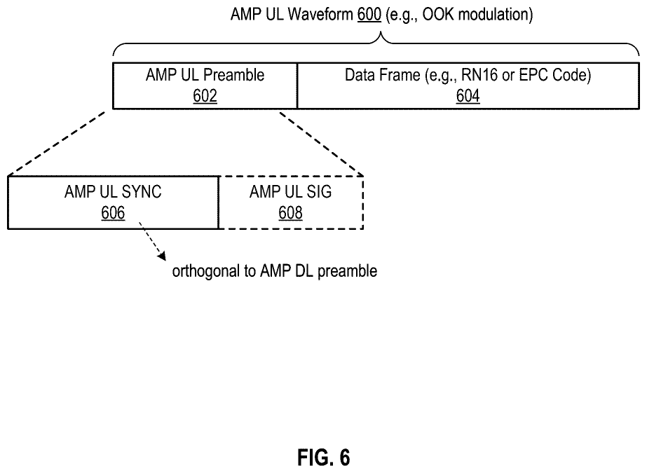

FIG. 6 illustrates an example of an AMP uplink (UL) waveform 600 in accordance with one or more embodiments of the present disclosure. In this example, an energizing period before the AMP UL waveform 600 may charge the AMP tag that transmits the AMP UL waveform 600 via an OOK modulated carrier signal (i.e., backscattered transmission). In an example, the WiFi reader providing the carrier waveform may utilize this charging period to estimate direct leakage signals to be canceled from the AMP UL waveform 600. The illustrated AMP UL waveform 600 includes an AMP UL preamble 602 and a data frame 604. The data frame 604 may carry, for example, data bits related to RN16 data and/or EPC code data, sensor data, etc.

In this example the AMP UL preamble 602 includes an AMP UL SYNC field 606 that includes an On-Off keying (OOK) modulated SYNC sequence such as described more fully below. The SYNC sequence can be used by a WiFi reader, for example, to determine a starting point of the data frame 604, and can be designed to accommodate low receive SNR and high ppm conditions at a receiving WiFi reader in order to improve detection and decrease false alarm detection probability from noise and all energy waveforms. In an example, the AMP UL preamble 602 further includes an AM UL SIG field 608 (e.g., to indicate a PPDU type and duration, configuration information, etc.). In a further example, the AMP UL SYNC field 606 is orthogonal to a received AMP DL preamble.

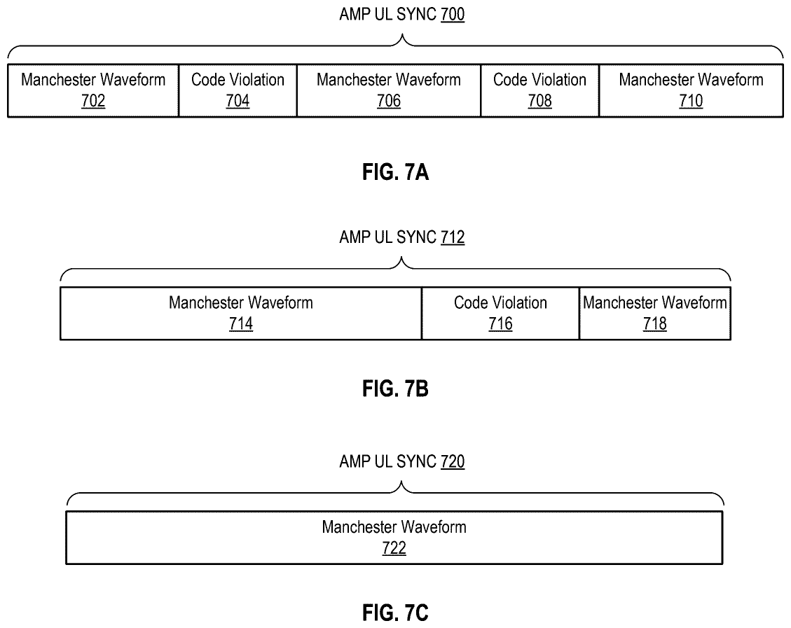

FIG. 7A illustrates an example of an AMP uplink (UL) SYNC field 700 in accordance with an embodiment of the present disclosure. In this example, the AMP UL SYNC field 700 includes a Manchester encoded waveform (“Manchester waveform”) 702, a first code violation 704, a Manchester waveform 706, a second code violation 708, and a Manchester waveform 710. In an example, the code violation period has the same length as a Manchester bit. Due to the transition state in the middle of each Manchester code, a Manchester encoded waveform is suitable for performing timing synchronization at a receiver with high ppm. Through the decoding of Manchester bits, UL SYNC detection can be performed and, with the proper selection of the number of Manchester bits, the false alarm rate at a receiver can be kept low.

The first code violation 704 of this example can be an all OFF period or an all ON period, and functions to lower the false trigger rate due to noise as compared with Manchester decoding. Due to low SNR at a WiFi reader, and to enable reliable code violation detection, the second code violation 708 can be included such that it is jointly detected with the first code violation 704. In order to make code violation detection robust to ppm, if a code violation is an all OFF period, the Manchester bit on the left of code violation could be set to be 0 (ON/OFF pattern) while the Manchester bit on the right of code violation could be set to be 1 such that the code violation is surrounded by the OFF pattern. If a code violation is all ON period, the Manchester bit on the left/right side of the code violation could be set to be 1 and 0, respectively. The second Manchester waveform 706 between the two code violations 704 and 708 may help to resync timing before the second code violation 708. In this example, the third Manchester waveform 710 can function to further refine the timing synchronization prior to data frame decoding. In an example, a WiFi reader needs to correctly detect all Manchester encoded bits and code violations for successful SYNC detection.

FIG. 7B illustrates another example of an AMP UL SYNC field 712 in accordance with an embodiment of the present disclosure. The illustrated AMP UL SYNC field 712 includes a Manchester waveform 714, a code violation 716, and a Manchester waveform 718. In this example, the Manchester waveform 714 provides for SYNC detection and ppm estimation, and the code violation 716 is longer than one Manchester bit. In an example, the code violation 716 can be an all ‘OFF’ or all ‘ON’ period. The longer time length of the code violation 716 (e.g., 2 or 3 times the length of a Manchester bit) may help mitigate false alarms due to noise signals. The Manchester waveform 718 (e.g., one Manchester bit) is included for purposes of timing resynchronization. In an example, a WiFi reader needs to correctly detect all Manchester encoded bits and code violations for successful SYNC detection.

FIG. 7C illustrates another example of an AMP UL SYNC field 720 in accordance with an embodiment of the present disclosure. In this example, the AMP UL SYNC field 720 consists of a Manchester waveform. A WiFi reader may need to correctly detect all of the included Manchester encoded bits for successful SYNC detection. Through proper selection of the number of Manchester encoded bits, the false alarm rate triggered by noise can be kept low.

In the AMP UL SYNC field of FIGS. 7A-7C, the time duration of a Manchester bit (i.e., two PWs) can be set to the same length as the length of a data bit in a corresponding data frame, for example:
for 250 kbps, one PW=2 us
for 1 Mbps, one PW=0.5 us
for 4 Mbps, one PW=0.125 us.

In another example, the time duration of a Manchester bit (i.e., two PWs) in an AMP UL SYNC field may be set to a fixed value regardless of the data rate (e.g., one PW=2 us). If the data portion is further encoded with an error correction code such as a Binary Convolution Code (BSS), the PW may be reduced depending on the coding ratio. For example, if the coding ratio is ½, the PW can be reduced by ½. In another example, the PW does not change based on a coding ratio.

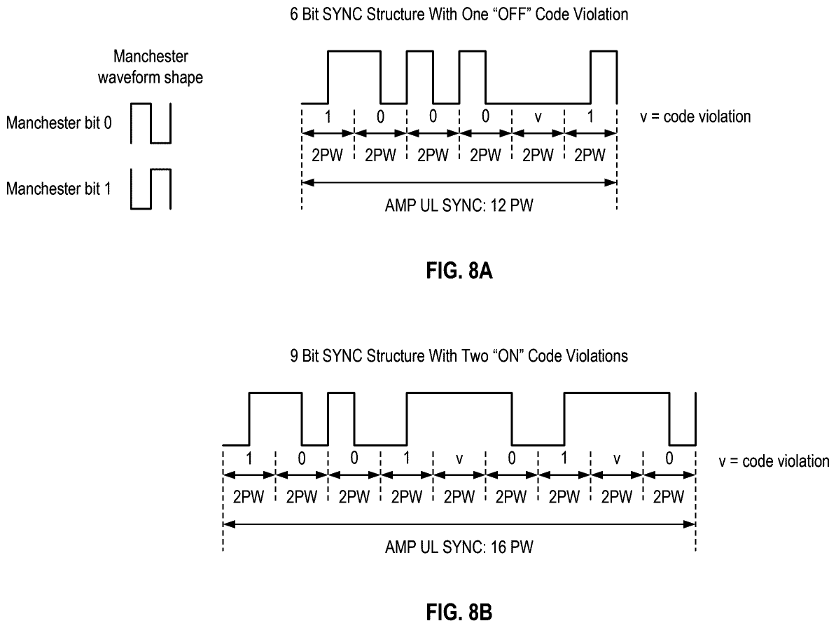

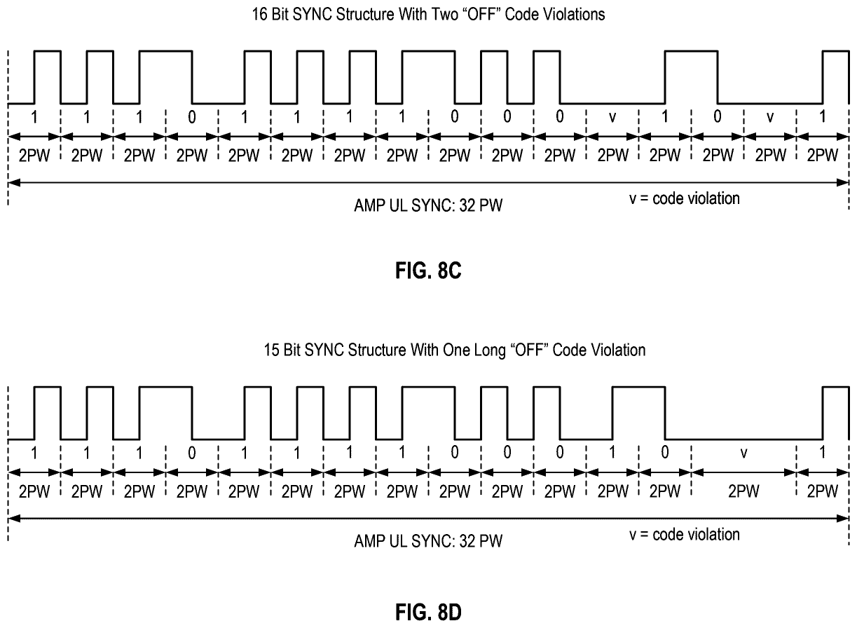

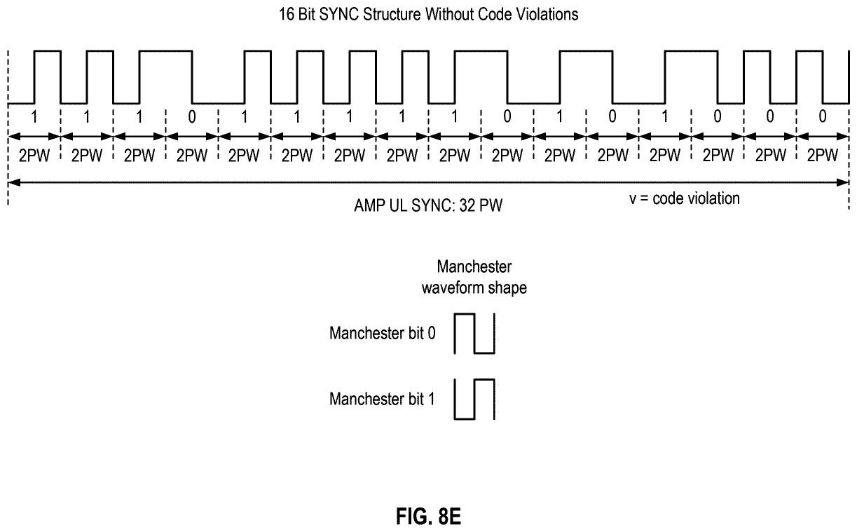

FIGS. 8A-8E illustrate various examples of the contents of an AMP UL SYNC field in accordance with embodiments of the present disclosure. In each of these examples, a single Manchester encoded bit has a duration of 2 pulse widths (PWs), and each pulse has a PW of 0.5 us or 2 us. Referring first to FIG. 8A, and example of a 6 bit SYNC structure with one (OFF) code violation is illustrated (code violations are labeled as “v” in these examples). In the illustrated example, the AMP UL SYNC field includes a 6-bit sequence of [1 0 0 0 v 1], where the Manchester bit preceding the code violation is 0 and the Manchester bit following the code violation is 1.

FIG. 8B illustrates another example of an AMP UL SYNC field in accordance an embodiment of the present disclosure. In this example, the AMP UL SYNC field includes a 9-bit SYNC sequence of [1 0 0 1 v 0 1 v 0] with two (ON) code violations. The Manchester bit preceding each code violation is 1 and the Manchester bit following each code violation is 0.

FIG. 8C illustrates another example of an AMP UL SYNC field in accordance an embodiment of the present disclosure. In this example, the AMP UL SYNC field includes a 16-bit SYNC sequence of [1 1 1 0 1 1 1 1 0 0 0 v 1 0 v 1] with two (ON) code violations. The Manchester bit preceding each code violation of this example is 1 and the Manchester bit following each code violation is 0. The Manchester bit preceding each code violation is 0 and the Manchester bit following each code violation is 1.

FIG. 8D illustrates another example of an AMP UL SYNC field in accordance an embodiment of the present disclosure. In this example, the AMP UL SYNC field includes a 15-bit SYNC sequence of [1 1 1 0 1 1 1 1 0 0 0 1 0 v 1] with one long (OFF) code violation that is twice the length of a Manchester bit. The Manchester bit preceding the long code violation is 0 and the Manchester bit following the long code violation is 1.

FIG. 8E illustrates another example of an AMP UL SYNC field in accordance an embodiment of the present disclosure. In this example, the AMP UL SYNC field includes a 16-bit SYNC sequence of [1 1 1 0 1 1 1 1 1 0 1 0 1 0 0 0] with no code violations.

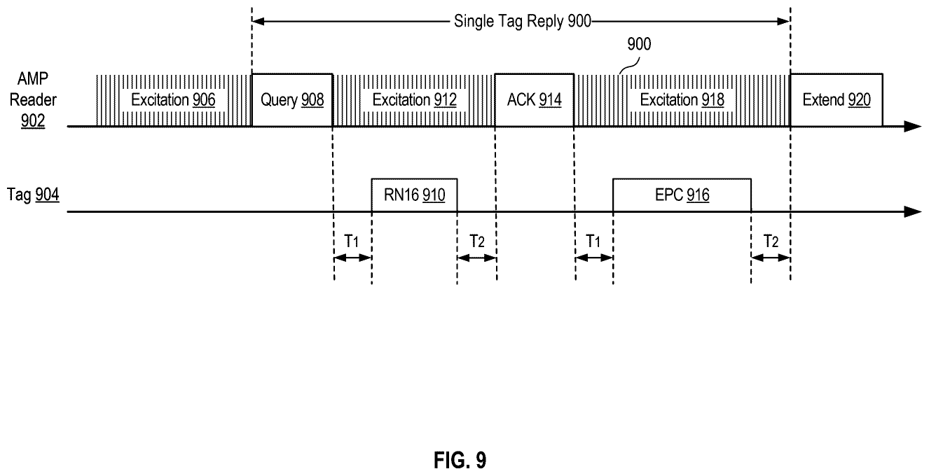

FIG. 9 illustrates an example of a WiFi backscatter communication 900 between an AMP reader 902 and an AMP tag 904 in accordance with embodiments of the present disclosure. In operation, the AMP (WiFi) reader 902 transmits a carrier waveform to modulate downlink (DL) control information and to supply energy for the AMP tag 904 during interframe spaces (IFSs) and during uplink (UL) backscattering communications. In order to improve detection of backscattering information through cancellation of leakage signals at the AMP reader 902, the AMP reader 902 may perform leakage signal estimation on reference signals included in the excitation waveform(s).

In the illustrated AMP tag reading operation, the AMP reader 902 transmits a first excitation waveform 906 followed by a query 908. After a first IFS time (T1) portion of excitation waveform 912, the AMP tag 904 transmits a response frame including, in this example, RN16 data. The RN16 data can a 16-bit random number that is generated by AMP tag 904 in response to the query 908, and functions as an per-session, anti-collision token. Following a second IFS time (T2) portion of the excitation waveform 912, the AMP reader 902 transmits an ACK 914 to acknowledge the RN16, effectively singulating the AMP tag 904 from any other nearby tags before an tag identification (ID) data is sent. Following another IFS (T1 of excitation waveform 918), the AMP tag 904 transmits a frame containing an EPC 916 value payload. The EPC 916 of this example is a tag identifier value stored in memory of the AMP tag (e.g., a 96 bit value or other standardized length). Backscatter wireless communication between the AMP reader 902 and AMP tag 904 may continue during an extended portion 920 (e.g., to read sensor data or other information stored in the AMP tag 904, etc.).

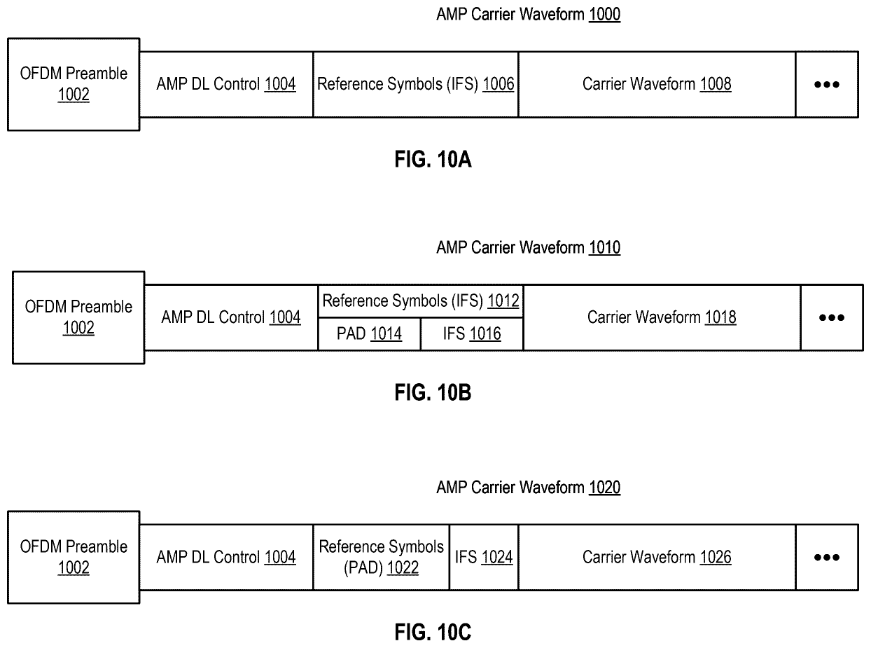

FIGS. 10A-10C illustrate further examples of an AMP DL carrier waveforms including reference symbols for leakage signal estimation in accordance with embodiments of the present disclosure. Examples of reference symbols are described with reference to FIGS. 12A-13B. In the illustrated examples of FIGS. 10A-10C, an AMP carrier waveform is preceded by an OFDM preamble 1002. In various embodiments, the OFDM preamble 1002 is configured to provide coexistence with legacy WiFi devices, and can be an OFDM preamble that is formatted in accordance with an IEEE 802.11 standard/amendment, such as 802.11g/n/ac/ax/be. In another example, the OFDM preamble 1002 may instead be formatted as an (non-OFDM) 802.11b preamble. In the illustrated examples, the OFDM preamble 1002 is followed by an AMP DL control frame 1004.

Referring to FIG. 10A, an AMP carrier waveform 1000 including an AMP DL control frame 1004, reference symbols 1006, and a carrier waveform 1008 (for backscattering communications by an AMP tag device) is illustrated. In this example, the reference symbols 1006 are transmitted by an AMP/WiFi reader during an interframe space (IFS) following the AMP DL control frame 1004.

FIG. 10B illustrates an AMP carrier waveform 1010 including an AMP DL control frame 1004, reference symbols 1012, and a carrier waveform 1018. In this example, the reference symbols 1012 are transmitted during each of a padding field 1014 of the AMP DL control frame 1004 and an IFS 1016.

FIG. 10C illustrates an AMP carrier waveform 1020 including an AMP DL control frame 1004, reference symbols 1022, an IFS 1024, and a carrier waveform 1026. In this example, the reference symbols 1022 are transmitted during a padding field of the AMP DL control frame 1004. In any of the foregoing examples, reference symbols can be further inserted periodically during a carrier waveform.

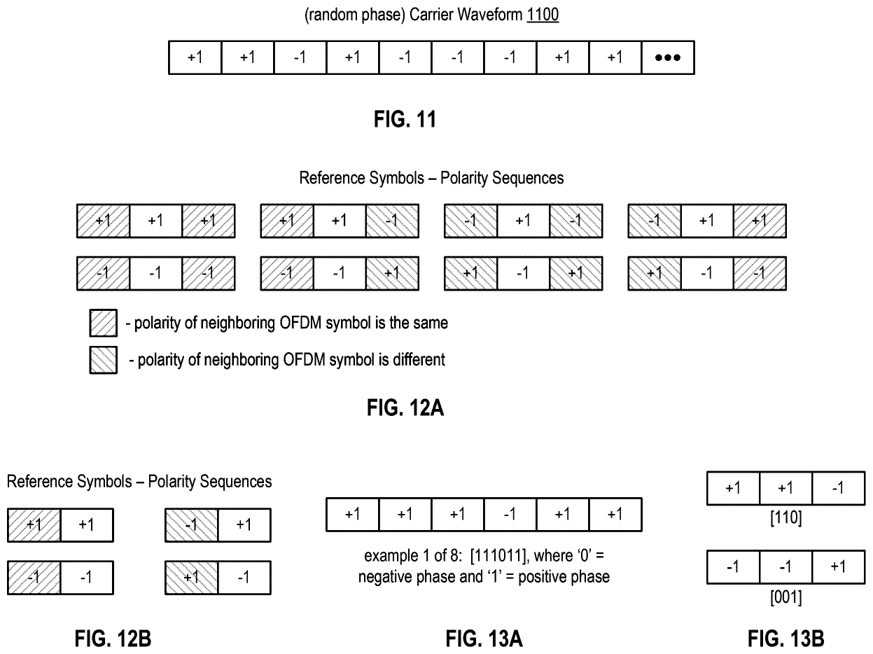

FIG. 11 illustrates an example of a random phase carrier waveform 1100 in accordance with an embodiment of the present disclosure. In general, in the examples described below the excitation carrier waveform for backscattered communications includes a repetitive sequence of carrier symbols such that an AMP reader can remove direct leakage based on estimated signal leakage values determined through reference symbols. In an example, the leakage signals will be distorted by inter-symbol-interference (ISI) due to both the hardware channel and the over-the-air-channel, and the reference waveform (produced by reference signals) includes the same symbols used for the backscattering carrier waveform.

In order to control the spectrum of the carrier waveform, random phase can be added to the carrier waveform such illustrated by the random phase carrier waveform 1100, and the ISI will be dependent on the polarity of neighboring symbols. Accordingly, as described below, the one or more reference symbols should include the various phase polarity sequences of the repetitive sequence of carrier symbols of the carrier waveform in order to provide accurate signal leakage estimation.

FIG. 12A illustrates examples of polarity sequences for reference symbols in accordance with embodiments of the present disclosure. In the illustrated examples, the binary polarity of carrier symbols is shown, and the “leakage” OFDM symbol has four possible values depending on the polarity of neighboring symbols. In an example polarity sequence of [+1 +1 +1], the polarity of the middle symbol is the same as neighboring symbols, and in an example sequence of [−1 +1 −1], the polarity of the middle symbol is different than the neighboring symbols. In order to cover all such polarity patterns, the required number of reference symbols is 3×4=12 symbols, or 24 symbols when a complementary sequence is included.

FIG. 12B illustrates additional examples of polarity sequences for reference symbols in accordance with embodiments of the present disclosure. In these examples, signal leakage due to the non-causal effect of the over-the-air channel is ignored. In this instance, there are four polarity of sequences to be considered for constructing reference signals, and the required number of reference signals is 2×2=4 symbols, or 8 symbols when a complementary sequence is included.

FIG. 13A illustrates an example of reference symbols in which the polarity of both neighboring symbols is considered as described in conjunction with FIG. 12A. In particular, for a sequence of six reference symbols with a predefined polarity sequence, there are eight possible cases (where “0” means negative phase and “1” means positive phase): P1—‘000100’, P2—‘001000’, P3—‘010001’, P4—‘011101’, P5—‘100010’, P6—‘101110’, P7—‘110111’, and P8 (the illustrated sequence)—‘111011’. In other examples, 11 (or 12) reference symbols with a predefined polarity sequence can be utilized, where a complementary sequence is concatenated to reduce one of the phase transitions. In examples, P6 and P3 are concatenated as ‘10111010001’ or P5 and P4 are concatenated as ‘10001011101’. In addition, the same reference symbol polarity sequence may be repeated N times to provide for better leakage signal estimation.

FIG. 13B illustrates additional examples of reference symbols in accordance with one or more embodiments of the present disclosure. In these examples, only the polarity of a preceding symbol is considered as described with reference to FIG. 12B, and a sequence of three reference symbols with a predefined polarity sequence includes P1—‘+1 +1 −1’ and P2—‘−1 −1 +1’. In other examples, 5 (or 6) reference symbols with a predefined polarity sequence can be utilized, where a complementary sequence is concatenated to reduce one of the phase transitions. In examples, P1 and P2 are concatenated as ‘11001’ or P2 and P1 are concatenated as ‘001110’, and the same reference symbol polarity sequence may be repeated N times to provide for better leakage signal estimation.

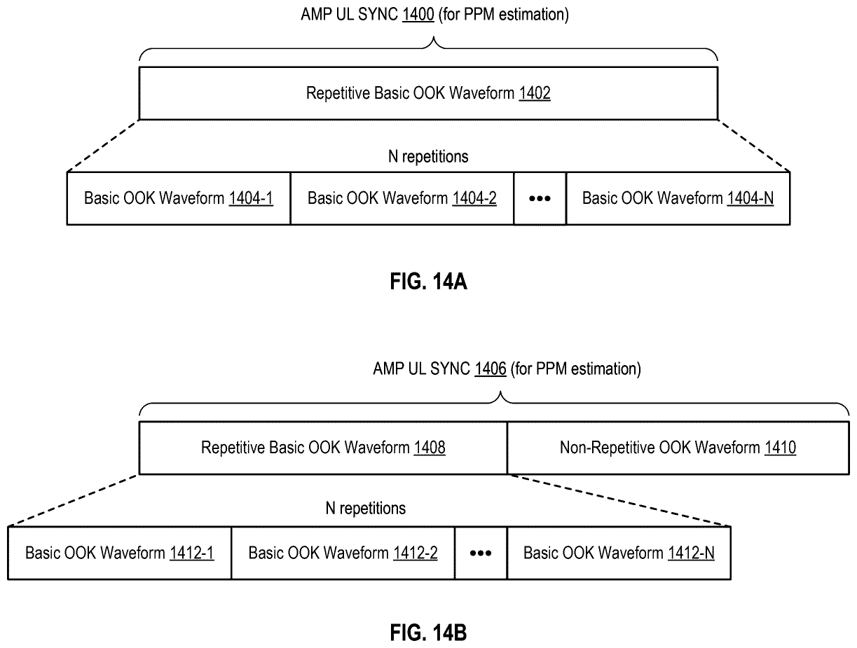

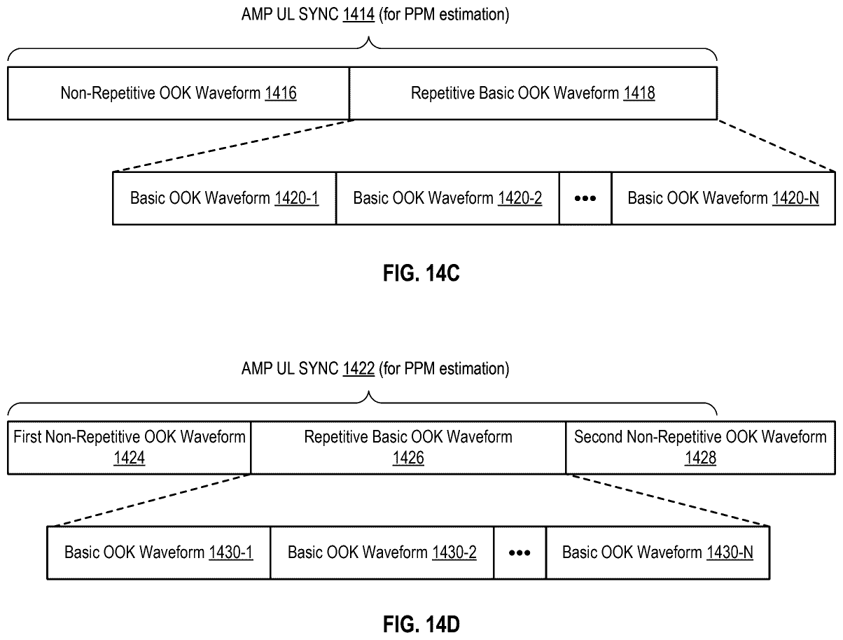

FIGS. 14A-14D illustrate examples of an AMP UL SYNC field including a repetitive basic OOK waveform (or sequence) in accordance with embodiments of the present disclosure. The AMP UL SYNC field may be utilized by a WiFi reader to perform ppm estimation, to detect the starting point of an UL data frame, and for SYNC validation. In an example, the backscatter signal received by a WiFi reader from an AMP tag device may have ppm impairments up to 100,000 ppm. A WiFi reader can optimize its receive (Rx) performance if the value of ppm is known, and the earlier the ppm value is known the better the performance that can be achieved. In the following examples, repetitive ppm estimation signals/waveforms are included in the SYNC field of an UL AMP preamble to facilitate timely estimation of ppm. Using the repetitive structure of the SYNC field, a WiFi reader can detect the time duration between the correlation peak of each copy of the base OOK sequence, and estimate the ppm value of the AMP tag's operating clock inaccuracy. In each of these examples, the repetitive basic OOK waveform can be a repetitive Manchester encoded waveform.

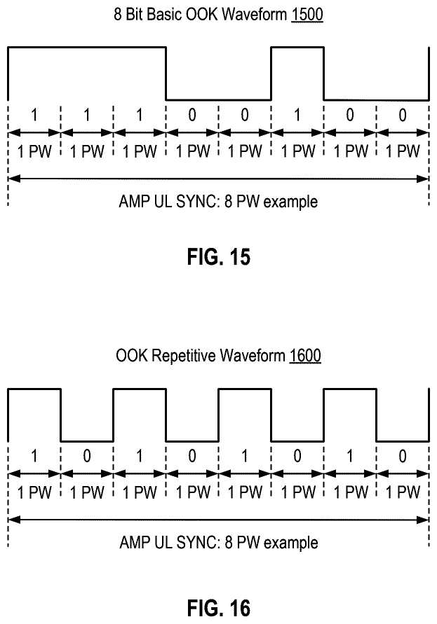

Referring first to FIG. 14A, an AMP UL SYNC field 1400 including a repetitive basic OOK waveform 1402 is illustrated. In this example, the repetitive basic OOK waveform includes N repetitions of a basic OOK waveform, where N>1. In an example, the number (N) of repetitions is 3. Examples of a basic OOK waveform are described in greater detail in conjunction with FIG. 15 and FIG. 16.

FIG. 14B illustrates an example of an AMP UL SYNC field 1406 including a repetitive basic OOK waveform in accordance with embodiments of the present disclosure. In this example, an AMP UL SYNC field 1406 includes a repetitive basic OOK waveform 1408 and a non-repetitive OOK waveform 1410. The repetitive basic OOK waveform 1408 includes N (where N>1) repetitions of a basic OOK modulated sequence 1412. The non-repetitive OOK waveform 1410 of this example includes an OOK sequence without a repetitive structure, and can be included for purposes of further SYNC validation and to facilitate timing synchronization. In an example, the non-repetitive OOK waveform 1410 may include a beginning portion of the basic OOK waveform 1412. Non-limiting examples of the AMP UL SYNC field 1406 include the following, where the non-repetitive OOK waveform 1410 has a value of [1]:

Basic OOK waveform [1 0 1 1 1 0 0] with repetition N=2 or 3: [1 0 1 1 1 0 0 1 0 1 1 1 0 0 1] or [1 0 0 1 0 1 1 1 0 0 1 0 1 1 1 0 0 1], and

Basic OOK waveform [1 1 0 0 1 0 1 0] with repetition N=2 or 3: [1 1 0 0 1 0 1 0 1 1 0 0 1 0 1 0 1] or [1 1 0 0 1 0 1 0 1 1 0 0 1 0 1 0 1 1 0 0 1 0 1 0 1].

FIG. 14C illustrates an example of an AMP UL SYNC field 1414 including a repetitive basic OOK waveform in accordance with embodiments of the present disclosure. Similar to the example of FIG. 14B, the illustrated AMP UL SYNC field 1414 includes a non-repetitive OOK waveform 1416 that, in this example, precedes a repetitive basic OOK waveform 1418. The repetitive basic OOK waveform 1418 includes N (where N>1) repetitions of a basic OOK modulated sequence 1420. In an example, the non-repetitive OOK waveform 1416 may include an ending portion of the basic OOK waveform 1420.

FIG. 14D illustrates another example of an AMP UL SYNC field 1422 including a repetitive basic OOK waveform in accordance with embodiments of the present disclosure. In this example, AMP UL SYNC field 1422 includes a first non-repetitive OOK waveform 1424, a repetitive basic OOK waveform 1426, and a second non-repetitive OOK waveform 1428. The first non-repetitive OOK waveform 1424 may utilized for SYNC validation, and includes an OOK sequence without a repetition structure (e.g., an ending portion of a basic OOK waveform). The repetitive basic OOK waveform 1426 includes N (where N>1) repetitions of a basic OOK modulated sequence 1430. The second non-repetitive OOK waveform 1428 may be utilized for further SYNC validation and timing synchronization, and may include, for example, the beginning portion of a basic OOK waveform.

In the AMP UL SYNC field of FIGS. 14A-14D, the time duration of an OOK bit (i.e., 1 PW) can be set to half the length of a data bit in a corresponding data frame, for example:
for 250 kbps, one PW=2 us
for 1 Mbps, one PW=0.5 us
for 4 Mbps, one PW=0.125 us.

If the data portion is further encoded with an error correction code such as a Binary Convolution Code (BSS), the PW may be reduced depending on the coding ratio. For example, if the coding ratio is ½, the PW can be reduced by ½. In another example, the PW does not change based on a coding ratio. In a further example, the time duration of an OOK bit (i.e., one PW) in an AMP UL SYNC field may be set to a fixed value regardless of the data rate (e.g., one PW=2 us).

FIG. 15 illustrates an example of an 8 bit basic OOK waveform 1500 of an UL AMP SYNC field in accordance with embodiments of the present disclosure. In general, the basic OOK waveform should be selected to meet good autocorrelation and cyclic autocorrelation properties. In the illustrated example, the basic OOK waveform 1500 (which may also be referred to herein as a “basic OOK modulated sequence” or “basic OOK sequence”) is a length 8 (PW) sequence of [1 1 1 0 0 1 0 0]. Other examples of basic OOK waveforms of various lengths include the following, where “1” corresponds to an OOK ON duration and “0” corresponds to an OOK OFF duration:
Length 2: [1 0], [0 1] (note that this is a Manchester waveform)
Length 3: [1 1 0]
Length 4: [1 1 0 0], [0 1 1 0]
Length 5: [0 1 1 1 0]
Length 6: [1 1 1 0 0 0], [0 0 1 1 1 0], [0 1 1 1 0 0], [1 0 1 1 0 0]
Length 7: [1 0 1 1 1 0 0], [1 1 1 0 0 1 0], [1 0 1 0 1 1 0]
Length 8: [1 1 1 1 0 0 0 0], [0 1 1 1 0 0 1 0], [1 0 1 0 1 1 0 0], [1 1 0 0 1 0 1 0]
Length 9: [0 1 1 1 1 0 0 1 0], [0 1 1 0 1 1 1 0 0], [1 1 0 0 1 1 0 1 0]
Length 10: [1 1 1 1 1 0 0 0 0 0], [1 1 1 1 1 0 0 0 0 0], [1 1 1 0 1 0 0 1 0 0], [1 1 1 1 0 0 0 1 0 0], [0 1 1 0 1 1 1 0 0 0], [0 1 1 1 0 1 0 0 1 0], [1 1 0 0 1 1 0 1 0 0]
Length 11: [0 1 0 1 1 0 1 1 1 0 0], [1 1 0 1 1 0 1 0 0 0 1]
Length 12: [1 1 1 1 1 1 0 0 0 0 0 0], [1 1 1 1 0 1 1 0 0 0 0 0], [1 1 1 0 1 1 1 0 0 0 0 0], [1 0 1 1 0 1 1 1 0 0 0 0], [1 0 0 1 0 1 1 1 1 0 0 0], [1 0 0 1 1 1 1 0 1 0 0 0], [0 1 0 1 1 0 1 1 1 0 0 0], [0 1 0 1 0 1 1 0 1 1 0 0]
Length 14: [1 1 1 1 1 1 1 0 0 0 0 0 0 0], [1 1 1 1 0 1 1 1 0 0 0 0 0 0], [1 1 0 1 1 1 1 0 0 0 1 0 0 0], [1 1 1 1 0 0 1 1 0 0 1 0 0 0], [1 0 1 1 1 0 0 1 1 0 1 0 0 0], [1 1 0 0 1 1 1 1 0 1 0 0 0 0], [1 1 0 1 1 0 0 1 1 1 0 0 0 0], [1 1 1 1 0 0 0 1 1 0 0 1 0 0], [1 1 0 1 1 0 0 1 1 1 0 0 0 0]
Length 16: [1 1 1 1 1 1 1 1 0 0 0 0 0 0 0 0], [1 1 1 1 1 0 1 1 1 0 0 0 0 0 0 0], [1 1 1 1 0 1 1 1 1 0 0 0 0 0 0 0], [1 1 1 0 1 0 1 1 0 1 1 0 0 0 0 0], [1 0 0 1 1 0 1 0 1 1 1 1 0 0 0 0], [0 0 1 1 1 0 1 0 1 1 0 0], [1 1 0 0 0 0 1 1 0 1 1 0 1 0 1 0]

FIG. 16 illustrates an example of a repetitive OOK waveform 1600 with a length of 8 (PW) in accordance with embodiments of the present disclosure. In this example, the repetitive OOK waveform 1600 (which may also be referred to herein as a “repetitive OOK modulated sequence” or “repetitive OOK sequence”) utilizes a length 2 basic OOK waveform of [1 0] with repetition N=4: [1 0 1 0 1 0 1 0]. In another example, the basic OOK waveform is [0 1 1 0] with repetition N=2: [0 1 1 0 0 1 1 0]. Other examples of a repetitive OOK modulated sequences (of an UL AMP SYNC field) of various lengths include the following, where “1” corresponds to an OOK ON duration and “0” corresponds to an OOK OFF duration:

### Length 12:

Basic OOK waveform [1 0] with repetition N=6: [1 0 1 0 1 0 1 0 1 0 1 0]
Basic OOK waveform [0 1 1 0] with repetition N=3: [0 1 1 0 0 1 1 0 0 1 1 0]
Basic OOK waveform [0 0 1 1 1 0] with repetition N=2: [0 0 1 1 1 0 0 0 1 1 1 0]
Basic OOK waveform [1 0 1 1 0 0] with repetition N=2: [1 0 1 1 0 0 1 0 1 1 0 0]

### Length 14:

Basic OOK waveform [1 0] with repetition N=7: [1 0 1 0 1 0 1 0 1 0 1 0 1 0 1 0]
Basic OOK waveform [1 0 1 1 1 0 0] with repetition N=2: [1 0 1 1 1 0 0 1 0 1 1 1 0 0]
Basic OOK waveform [1 1 1 0 0 1 0] with repetition N=2: [1 1 1 0 0 1 0 1 1 1 0 1 1 0]
Basic OOK waveform [1 0 1 0 1 1 0] with repetition N=2: [1 0 1 0 1 1 0 1 0 1 0 1 1 0]

### Length 16:

Basic OOK waveform [1 0] with repetition N=8: [1 0 1 0 1 0 1 0 1 0 1 0 1 0 1 0]
Basic OOK waveform [0 1 1 0] with repetition N=4: [0 1 1 0 0 1 1 0 0 1 1 0 0 1 1 0]
Basic OOK waveform [1 1 1 0 0 1 0 0] with repetition N=2: [1 1 1 0 0 1 0 0 1 1 1 0 0 1 0 0]
Basic OOK waveform [0 1 1 1 0 0 1 0] with repetition N=2: [0 1 1 1 0 0 1 0 0 0 1 1 1 0 0 1 0]
Basic OOK waveform [1 0 1 0 1 1 0 0] with repetition N=2: [1 0 1 0 1 1 0 0 1 0 1 0 1 1 0 0]
Basic OOK waveform [1 1 0 0 1 0 1 0] with repetition N=2: [1 1 0 0 1 0 1 0 1 1 0 0 1 0 1 0]

### Length 18:

Basic OOK waveform [1 0] with repetition N=9: [1 0 1 0 1 0 1 0 1 0 1 0 1 0 1 0 1 0]
Basic OOK waveform [0 1 1 0 1 1 1 0 0] with repetition N=2: [0 1 1 0 1 1 1 0 0 0 1 1 0 1 1 1 0 0]
Basic OOK waveform [1 1 0 0 1 1 0 1 0] with repetition N=2: [1 1 0 0 1 1 0 1 0 1 1 0 0 1 1 0 1 0]

### Length 20:

Basic OOK waveform [0 1 1 0 1 1 1 0 0 0] with repetition N=2: [0 1 1 0 1 1 1 0 0 0 0 1 1 0 1 1 1 0 0 0]
Basic OOK waveform [0 1 1 1 0 1 0 0 1 0] with repetition N=2: [0 1 1 1 0 1 0 0 1 0 0 1 1 1 0 1 0 0 1 0]
Basic OOK waveform [1 0 1 0 0] with repetition N=2: [1 1 0 0 1 1 0 1 0 0 1 1 0 0 1 1 0 1 0 0]
Basic OOK waveform [1 1 01 1 0 0 0 1 0] with repetition N=2: [1 1 0 1 1 0 0 0 1 0 1 1 0 1 1 0 0 0 1 0]

### Length 21:

Basic OOK waveform [1 0 1 1 1 0 0] with repetition N=3: [1 0 1 1 1 0 0 1 0 1 1 1 0 0 1 0 1 1 1 0 0]
Basic OOK waveform [1 1 1 0 0 1 0] with repetition N=3: [1 1 1 0 0 1 0 1 1 1 0 0 1 0 1 1 1 0 0 1 0]
Basic OOK waveform [1 0 1 0 1 1 0] with repetition N=3: [1 0 1 0 1 1 0 1 0 1 0 1 1 0 1 0 1 0 1 1 0]

### Length 24:

Basic OOK waveform [1 0] with repetition N=12: [1 0 1 0 1 0 1 0 1 0 1 0 1 0 1 0 1 0 1 0 1 0 1 0]
Basic OOK waveform [0 1 1 0] with repetition N=6: [0 1 1 0 0 1 1 0 0 1 1 0 0 1 1 0 0 1 1 0 0 1 1 0]
Basic OOK waveform [0 0 1 1 1 0] with repetition N=4: [0 0 1 1 1 0 0 0 1 1 1 0 0 0 1 1 1 0 0 0 1 1 1 0]
Basic OOK waveform [1 1 1 0 0 1 0 0] with repetition N=3: [1 1 1 0 0 1 0 0 1 1 1 0 0 1 0 0 1 1 1 0 0 1 0 0]
Basic OOK waveform [0 1 1 1 0 0 1 0] with repetition N=3: [0 1 1 1 0 0 1 0 0 1 1 1 0 0 1 0 0 1 1 1 0 0 1 0]
Basic OOK waveform [1 0 1 0 1 1 0 0] with repetition N=3: [1 0 1 0 1 1 0 0 1 0 1 0 1 1 0 0 1 0 1 0 1 1 0 0]
Basic OOK waveform [0 1 1 1 0 0 0] with repetition N=2: [0 1 0 1 1 0 1 1 1 0 0 0 0 1 0 1 1 0 1 1 1 0 0 0]
Basic OOK waveform [0 1 0 1 0 1 1 0 1 1 0 0] with repetition N=2: [0 1 0 1 0 1 1 0 1 1 0 0 0 1 0 1 0 1 1 0 1 1 0 0]

### Length 30:

Basic OOK waveform [1 0] with repetition N=15: [1 0 1 0 1 0 1 0 1 0 1 0 1 0 1 0 1 0 1 0 1 0 1 0 1 0 1 0 1 0]
Basic OOK waveform [0 1 1 0 1 1 1 0 0 0] with repetition N=3: [0 1 1 0 1 1 1 0 0 0 0 1 1 0 1 1 1 0 0 0 0 1 1 0 1 1 1 0 0 0]
Basic OOK waveform [0 1 1 1 0 1 0 0 1 0] with repetition N=3: [0 1 1 1 0 1 0 0 1 0 0 1 1 1 0 1 0 0 1 0 0 1 1 1 0 1 0 0 1 0]
Basic OOK waveform [1 1 0 0 1 1 0 1 0 0] with repetition N=3: [1 1 0 0 1 1 0 1 0 0 1 1 0 0 1 1 0 1 0 0 1 1 0 0 1 1 0 1 0 0 1]

### Length 32:

Basic OOK waveform [1 0] with repetition N=16: [1 0 1 0 1 0 1 0 1 0 1 0 1 0 1 0 1 0 1 0 1 0 1 0 1 0 1 0 1 0 1 0]
Basic OOK waveform [0 1 1 0] with repetition N=8: [0 1 1 0 0 1 1 0 0 1 1 0 0 1 1 0 0 1 1 0 0 1 1 0 0 1 1 0 0 1 1 0]
Basic OOK waveform [1 1 1 0 0 1 0 0] with repetition N=4: [1 1 1 0 0 1 0 0 1 1 1 0 0 1 0 0 1 1 1 0 0 1 0 0 1 1 1 0 0 1 0 0]
Basic OOK waveform [0 1 1 1 0 0 1 0] with repetition N=4: [0 1 1 1 0 0 1 0 0 1 1 1 0 0 1 0 0 1 1 1 0 0 1 0 0 1 1 1 0 0 1 0]
Basic OOK waveform [1 0 1 0 1 1 0 0] with repetition N=4: [1 0 1 0 1 1 0 0 1 0 1 0 1 1 0 0 1 0 1 0 1 1 0 0 1 0 1 0 1 1 0 0]
Basic OOK waveform [1 1 0 0 1 0 1 0] with repetition N=4: [1 1 0 0 1 0 1 0 1 1 0 0 1 0 1 0 1 1 0 0 1 0 1 0 1 1 0 0 1 0 1 0]
Basic OOK waveform [0 0 1 1 1 0 1 0 1 1 0 1 1 0 0] with repetition N=2: [0 0 1 1 1 0 1 0 1 1 0 1 1 0 0 0 0 1 1 1 0 1 0 1 1 0 1 1 0 0]
Basic OOK waveform [1 1 0 0 0 0 1 1 0 1 1 0 1 0 1 0] with repetition N=2: [1 1 0 0 0 0 1 1 0 1 1 0 1 0 1 0 1 1 0 0 0 0 1 1 0 1 1 0 1 0 1 0]

In other embodiments, the basic OOK modulated sequence can be generated by performing at least one of a cyclic shift operation or a flip operation on a predetermined basic sequence. Under a cyclic shift operation, for a predetermined basic sequence S=[s₀s₁ . . . s_{N-1}], where sₖ, k∈{0, 1, 2 . . . N−1} can be 0 or 1 (representing OOK OFF and OOK ON, respectively), a new basic sequence S_{new} can be an M∈{0, 1, 2 . . . N−1} cycle shift of S, namely:

$${S}_{shift} = [ {s}_{M} {s}_{( M + 1 ) \% N} {s}_{( M + 2 ) \% N} … {s}_{( M + N - 1 ) \% N} ] ,$$

where % is a modulo operator.

Under a “flip” operation, for a predetermined basic sequence S=[s₀s₁ . . . S_{N-1}], where sₖ, k∈{0, 1, 2 . . . . N−1} can be 0 or 1 (representing OOK OFF and OOK ON, respectively), a new basic sequence S_{new} can be generated by flip S, namely:

$${S}_{flip} = [ {s}_{N - 1} {s}_{N - 2} {s}_{N - 3} … {s}_{1} {s}_{0} ] .$$

Under a hybrid approach, a new basic sequence S_{new} can be generated by performing both a cyclic shift operation and a flip operation on a predetermined basic sequence. For example, a cyclic shift operation can be performed on the predetermined basic sequence followed by a flip operation, or a flip operation can be performed on the predetermined basic sequence followed by a cyclic shift operation. The predetermined basic sequence can be, for example, any sequence described in the present disclosure. In an example, for a predetermined length 8 basic sequence S=[1 0 1 0 1 1 0 0], a new length 8 basic sequence is generated by performing an M=6 cyclic shift of S and then performing a flip operations, namely S_{new}=[1 1 0 1 0 1 0 0].

In a further example, for a (predetermined) length 10 basic sequence S=[0 1 1 0 1 1 1 0 0 0], a new length 10 basic sequence is generated by performing an M=1 cyclic shift of S, namely S_{new}=[1 1 0 1 1 1 0 0 0 0]. In another example, for a length 10 basic sequence S=[0 1 1 0 1 1 1 0 0 0], a new length 10 basic sequence is generated by performing an M=7 cyclic shift of S, and then performing a flip operation, namely S_{new}=[1 1 1 0 1 1 0 0 0 0].

In a further example, for a (predetermined) length 12 basic sequence S=[0 1 0 1 1 0 1 1 1 0 0 0], a new length 12 basic sequence is generated by performing an M=1 cyclic shift of S, namely S_{new}=[1 0 1 1 0 1 1 1 0 0 0 0]. In another example, for a length 12 basic sequence S=[0 1 0 1 1 0 1 1 1 0 0 0], a new length 12 basic sequence is generated by performing an M=7 cyclic shift of S, and then performing a flip operation, namely S_{new}=[1 1 1 0 1 1 0 1 1 0 0 0].

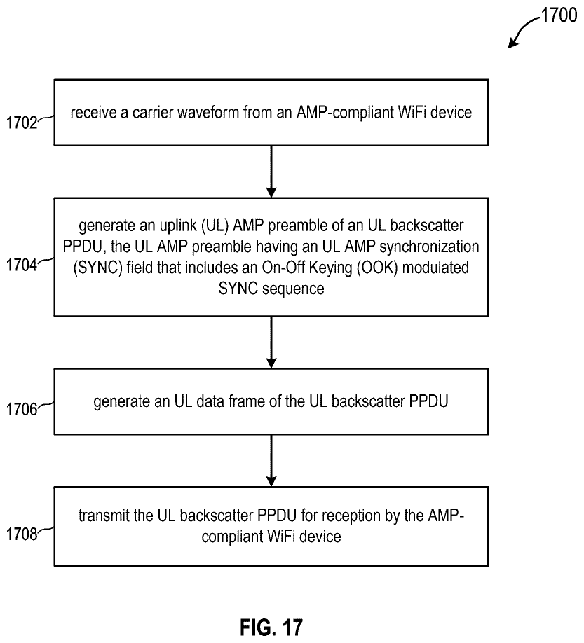

FIG. 17 is a flow chart illustrating an example method 1700 for generating an AMP UL SYNC field in accordance with one or more embodiments of the present disclosure. The method 1700 can be performed by an AMP tag device, such as the AMP tag device 112 described with reference to FIG. 1. The method 1700 may be utilized, for example, to perform AMP communications with an AMP-compliant WiFi reader (e.g., in accordance with the 802.11 bp amendment to the IEEE 802.11 standard). The method begins at step 1702, where the AMP tag device receives a carrier waveform from an AMP-compliant WiFi device. The method continues at step 1704 where the AMP tag device generates an uplink (UL) AMP preamble of an UL backscatter PPDU. In this example, the UL AMP preamble includes an UL AMP synchronization (SYNC) field that includes an On-Off keying (OOK) modulated SYNC sequence, examples of which are described with reference to FIGS. 6-16. The illustrated method continues at step 1706, where the AMP tag device generates an UL data frame of the UL backscatter PPDU. The method continues at step 1708 where the AMP tag device transmits the UL backscatter PPDU segment for reception by the AMP-compliant WiFi device.

While the innovative aspects of the present disclosure have been generally described in the context of the 802.11 bp amendment to the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative apparatus, frame formats, and methods illustrated in the figures and described herein to enable ambient power (AMP) uplink communications (e.g., via backscattering) that are compatible with legacy WiFi devices and support AMP tag devices having varying hardware and communication capabilities. In an illustrative, non-limiting embodiment, a method for uplink (UL) backscattering communications by an ambient power (AMP) tag device is provided. The method includes generating, by an AMP tag device, an UL backscatter physical layer protocol data unit (PPDU), the UL backscatter PPDU including an UL AMP preamble having an UL AMP synchronization (SYNC) field, wherein the UL AMP SYNC field includes an On-Off keying (OOK) modulated SYNC sequence. The UL backscatter PPDU further includes an UL data frame. The method further includes transmitting, by the AMP tag device, the UL backscatter PPDU for reception by an AMP-compliant WiFi device.

The method of this embodiment includes optional aspects. With one optional aspect, the SYNC sequence comprises a repetitive OOK modulated sequence. In another optional aspect, the repetitive OOK modulated sequence comprises N (where N>1) repetitions of a basic OOK modulated sequence. In yet another optional aspect, the number (N) of repetitions is 3.

In another optional aspect, the basic OOK modulated sequence is generated by performing at least one of a cyclic shift operation or a flip operation on a predetermined basic sequence. In a further optional aspect, the basic OOK modulated sequence has length of 8. In yet another optional aspect, the basic OOK modulated sequence is [1 1 0 1 0 1 0 0]. In a further optional aspect, the repetitive OOK modulated sequence is a Manchester encoded sequence.

In another optional aspect, a time duration of an OOK pulse waveform of the SYNC sequence is the same as a time duration of the ON waveform of a Manchester encoded bit of data of the UL data frame. In a further optional aspect, the SYNC sequence comprises at least one Manchester encoded portion and at least one code violation. In another optional aspect, the method further includes receiving an excitation carrier waveform from the AMP-compliant WiFi device, wherein transmitting the UL backscatter PPDU includes modulating the excitation carrier waveform. In a further optional aspect, the method further includes prior to transmitting the excitation carrier waveform for the UL backscatter PPDU, transmitting one or more reference symbols by the AMP-compliant WiFi device. In a still further optional aspect, the one or more reference symbols are configured to support leakage signal estimation by the AMP-compliant WiFi device. In yet another optional aspect, the excitation carrier waveform includes a repetitive sequence of carrier symbols with random phase polarities, and the one or more reference symbols include all phase polarity sequences of carrier symbols.

In another optional aspect, the UL backscatter PPDU further includes an UL AMP signaling (SIG) field that precedes the UL data frame. In a further optional aspect, the UL AMP preamble and AMP data frame are compliant with the IEEE 802.11 bp amendment to the IEEE 802.11 standard. In a still further optional aspect, the UL data frame includes at least one of RN116 data or EPC code data.

In another illustrative, non-limiting embodiment, a method for communicating with an ambient power (AMP) tag device by an AMP-compliant WiFi device is provided. The method includes generating a physical layer protocol data unit (PPDU), the PPDU including at least a preamble that is compliant with an Institute of Electrical and Electronics Engineers (IEEE) 802.11 standard, an AMP data segment, and a carrier waveform. The method further includes transmitting, by the WiFi device, the PPDU for reception by the AMP tag device, and receiving, in response to the PPDU, an UL backscatter PPDU segment. The UL backscatter PPDU segment includes an UL AMP preamble having an UL AMP synchronization (SYNC) field including a repetitive OOK modulated waveform and an UL data frame.

This second embodiment includes optional aspects. With one optional aspect, the UL AMP SYNC field comprises a repetitive basic OOK modulated sequence, and a time duration of an OOK pulse waveform is the same as a time duration of an ON waveform of a Manchester coded bit of data of the UL data frame.

With another illustrative, non-limiting embodiment, an ambient power (AMP) tag device is arranged to receive a carrier waveform from an AMP-compliant WiFi device. The AMP tag device is further arranged to generate an UL backscatter physical layer protocol data unit (PPDU), the UL backscatter PPDU including an UL AMP preamble having an UL AMP synchronization (SYNC) field that includes an On-Off keying (OOK) modulated SYNC sequence and an UL data frame. The method of this embodiment further includes transmitting, by the AMP tag device, the UL backscatter PPDU for reception by an AMP-compliant WiFi device.

This third embodiment includes optional aspects. With one optional aspect, the SYNC sequence comprises a repetitive OOK modulated sequence. In another optional aspect, the SYNC sequence comprises at least one Manchester encoded portion and at least one code violation.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for uplink (UL) backscattering communications by an ambient power (AMP) tag device, the method comprising:
generating an UL backscatter physical layer protocol data unit (PPDU), the UL backscatter PPDU including:
an UL AMP preamble having an UL AMP synchronization (SYNC) field, wherein the UL AMP SYNC field includes an On-Off keying (OOK) modulated SYNC sequence; and
an UL data frame; and
transmitting, by the AMP tag device, the UL backscatter PPDU for reception by an AMP-compliant WiFi device.

2. The method of claim 1, wherein the SYNC sequence comprises a repetitive OOK modulated sequence.

3. The method of claim 2, wherein the repetitive OOK modulated sequence comprises N (where N>1) repetitions of a basic OOK modulated sequence.

4. The method of claim 3, wherein the number (N) of repetitions is 3.

5. The method of claim 3, wherein the basic OOK modulated sequence is generated by performing at least one of a cyclic shift operation or a flip operation on a predetermined basic sequence.

6. The method of claim 3, wherein the basic OOK modulated sequence has length of 8.

7. The method of claim 3, wherein the basic OOK modulated sequence is [1 1 0 1 0 1 0 0].

8. The method of claim 2, wherein the repetitive OOK modulated sequence is a Manchester encoded sequence.

9. The method of claim 2, wherein a time duration of an OOK pulse waveform of the SYNC sequence is the same as a time duration of the ON waveform of a Manchester encoded bit of data of the UL data frame.

10. The method of claim 1, wherein the SYNC sequence comprises at least one Manchester encoded portion and at least one code violation.

11. The method of claim 1, further comprising:
receiving an excitation carrier waveform from the AMP-compliant WiFi device, wherein transmitting the UL backscatter PPDU includes modulating the excitation carrier waveform.

12. The method of claim 11, further comprising:
prior to transmitting the excitation carrier waveform for the UL backscatter PPDU, transmitting one or more reference symbols by the AMP-compliant WiFi device.

13. The method of claim 12, wherein the one or more reference symbols are configured to support leakage signal estimation by the AMP-compliant WiFi device.

14. The method of claim 12, wherein the excitation carrier waveform includes a repetitive sequence of carrier symbols with random phase polarities, and wherein the one or more reference symbols include all phase polarity sequences of carrier symbols.

15. The method of claim 1, wherein the UL backscatter PPDU further includes an UL AMP signaling (SIG) field that precedes the UL data frame.

16. The method of claim 1, wherein the UL AMP preamble and AMP data frame are compliant with the IEEE 802.11 bp amendment to the IEEE 802.11 standard.

17. The method of claim 1, wherein the UL data frame includes at least one of RN16 data or EPC code data.

18. A method for communicating with an ambient power (AMP) tag device by an AMP-compliant WiFi device, the method comprising:
generating a physical layer protocol data unit (PPDU), the PPDU including at least:
a preamble, wherein the preamble is compliant with an Institute of Electrical and Electronics Engineers (IEEE) 802.11 standard;
an AMP data segment; and
a carrier waveform;
transmitting, by the WiFi device, the PPDU for reception by the AMP tag device; and
receiving, in response to the PPDU, an UL backscatter PPDU segment, the UL backscatter PPDU segment including:
an UL AMP preamble having an UL AMP synchronization (SYNC) field including a repetitive OOK modulated waveform; and
an UL data frame.

19. The method of claim 18, wherein the UL AMP SYNC field comprises a repetitive basic OOK modulated sequence, and wherein a time duration of an OOK pulse waveform is the same as a time duration of an ON waveform of a Manchester coded bit of data of the UL data frame.

20. An ambient power (AMP) tag device arranged to:
receive a carrier waveform from an AMP-compliant WiFi device;
generate an UL backscatter physical layer protocol data unit (PPDU), the UL backscatter PPDU including:
an UL AMP preamble having an UL AMP synchronization (SYNC) field, wherein the UL AMP SYNC field includes an On-Off keying (OOK) modulated SYNC sequence; and
an UL data frame; and
transmit the UL backscatter PPDU for reception by the AMP-compliant WiFi device.

21. The AMP tag device of claim 20, wherein the SYNC sequence comprises a repetitive OOK modulated sequence.

22. The AMP tag device of claim 20, wherein the SYNC sequence comprises at least one Manchester encoded portion and at least one code violation.
